(19) United States
(12) Patent Application Publication
(10) Pub. No.: US 2007/0088103 A1
(43) Pub. Date: Apr. 19, 2007

(54) Composite article and method of manufacture using an isocyanate-terminated prepolymer as binder

(75) Inventor: Philippe Poncet, Rhinau (FR)

Correspondence Address: THE DOW CHEMICAL COMPANY, INTELLECTUAL PROPERTY SECTION,, P. O. BOX 1967, MIDLAND, MI, 48641-1967, US

(73) Assignee: Dow Global Technologies Inc., Midland, MI (US)

(21) Appl. No.: 11/541,732

(22) Filed: Oct. 2, 2006

Related U.S. Application Data
(60) Provisional application No. 60/726,897, filed on Oct. 14, 2005.

(51) Int. Cl. B29C 47/00; C08L 97/00; C08G 18/08

(52) U.S. Cl. 524/13; 524/589; 524/16

(57) ABSTRACT

The present invention relates to a composite article obtained from binding or adhesion of particulate matter with a polyurethane binder which is derived from a urethane-modified isocyanate obtained by reaction of an isocyanate with a polyether polyol based on an initiator containing a tertiary nitrogen atom. Such composite articles can be, for example, recreational matting or tiles, sports or running tracks, or flooring, or laminates.

This application claims the benefit of U.S. Provisional Application No. 60/726,897 filed Oct. 14, 2005.

### FIELD OF THE INVENTION

The present invention relates to a composite article of a bound particulate substance; a method of its fabrication employing as binder a select urethane-modified isocyanate adhesive; and to a laminate product wherein one or more layers comprises such a composite product.

### BACKGROUND OF THE INVENTION

The production of composite products from, for example, organic particles of rubber, synthetic resin, wood or inorganic particles such as sand or quartz, using polyurethane binders or adhesives, is generally known. For example, the use of two-component polyurethane binders for binding elastic particles has been described in German patent application DE 19 55 267 and in the Great Britain patent publications GB 1,373,923 and GB 1,359,761. Moisture curing one-component polyurethane binder is disclosed in the patent applications GB 1,384,619 and GB 1,294,017.

Typically, the composites based on known two-component polyurethane binders are obtained by mixing a polyisocyanate with a polyhydroxyl compound and compound simultaneously or subsequently with the particulate matter. The polyisocyanate in addition reacts with the moisture from the atmosphere. The proportions in which the two reactions take place depend, among other things, on the atmospheric humidity, and residual humidity within the particulate material, which affects the processing and end properties of the composite in a way which cannot easily be controlled. This disadvantage is mitigated to some extent by using one-component polyurethane binders which are hardened only by their reaction with the atmospheric moisture. Alternatively, the disadvantage may also be mitigated to a limited extent by selection of urethane catalyst present in the process.

One component binders typically consist of prepolymers that contain isocyanate groups and having been obtained from reaction of usually polyhydroxyl compound(s) with a molar excess of a polyisocyanate. The known one-component polyurethane binders, however, have various disadvantages depending on their chemical structure and reactivity. Prepolymers based on diphenylmethane-4,4′-diisocyanate have a tendency to crystallize at temperatures around 0° C. or slightly above and, therefore have storage and use constraints in cold conditions. Prepolymers based on commercial diphenylmethane diisocyanate and which may additionally contain triisocyanates and tetraisocyanates as well as higher functional polyisocyanates of the diphenylmethane series, have a much reduced tendency to crystallize, but on the other hand their viscosity at room temperature is so high that they are difficult to process without subsequent modification of their viscosity by the addition of thinners or solvents or alternatively elevated processing temperatures. The presence of solvents is not desirable as there is the risk that certain particulate matter may swell due to the absorption of solvent and subsequently be released in the curing process with potential to cause problems, for example, dimensional instability. Further increasing awareness of environmental concerns associated with volatile organic emissions make it desirable to avoid the presence of such solvent.

With respect to reactivity of the polyurethane binder system, it is quite common to use a catalyst to modify the reactivity profile. Selection of the type of catalyst may limit end applications of the resulting composite.

An alternative means of modifying the reactivity profile of a polyurethane system is to employ starting materials which are inherently more reactive, for example polyols containing tertiary nitrogen atoms. Isocyanate-terminated prepolymers based on polyols containing tertiary nitrogen are disclosed in various publications including the patent publications U.S. Pat. No. 3,317,481 and U.S. Pat. No. 4,426,487. The publication, EP 1,268,598 suggests the general preparation of isocyanate-terminated prepolymers suitable for flexible polyurethane foam production from polyols derived from alternative amine-initiators.

It is an object of this invention to mitigate the above-described disadvantages of known polyurethane binders and provide for manufacture of composite articles with an alternative polyurethane binder system accommodating one or more desires of the end user for a system having easier processing, including cure times and sensitivity to humidity; fewer limitations associated with sensitivity to presence of solvents or catalysts; and enhanced mechanical performance.

### SUMMARY OF THE INVENTION

The present invention relates to a composite article obtained from binding or adhesion of particulate matter with a polyurethane binder which is derived from a urethane-modified isocyanate obtained by reaction of an isocyanate with a polyether polyol derived from initiators containing a tertiary nitrogen. Such composite articles can be, for example, recreational matting or tiles, sports or running tracks, or flooring, or laminates.

In a first aspect this invention is a composite composed of particulate matter substantially coated with a non-foamed polyurethane binder based on a urethane-modified isocyanate characterized in that the urethane-modified isocyanate is the reaction product of:
a) a stoichiometric excess of an aliphatic or aromatic polyisocyanate, or mixtures thereof; with
b) a polyol composition that comprises a polyether polyol (b1) having a molecular weight of from about 1000 to about 12000 and being obtained by alkoxylation of at least one initiator molecule of the formula
   HₘA-(CH₂)ₙ—N(R)—(CH₂)ₚ-AHₘ Formula (I)
wherein n and p are independently integers from 2 to 6,
A at each occurrence is independently oxygen, nitrogen, sulphur or hydrogen, with the proviso that only one of A can be hydrogen at one time,
R is a C₁ to C₃ alkyl group,
m is equal to 0 when A is hydrogen, is 1 when A is oxygen and is 2 when A is nitrogen, or
   H₂N—(CH₂)ₜ—N—(R)—H Formula (II)
where t is an integer from 2 to 12 and
R is a C₁ to C₃ alkyl group.

In a second aspect, this invention is a process for manufacturing a composite comprising particulate matter substantially coated and bound together by a non-foamed polyurethane binder which comprises a first step of intimately contacting said particulate matter with a urethane-modified isocyanate composition and a subsequent step of permitting the resulting mixture to cure to give the composite article characterized in that the urethane-modified isocyanate is as described above.

In a third aspect, this invention is a laminate article comprising a first layer being in contact with a second layer and wherein at least one of the first or second layers is a composite as mentioned herein above.

In a fourth aspect this invention relates to a mat with an upper tufted pile textile surface comprising tufts of yam tufted into a substrate structure comprising an elastomeric backing derived from elastomeric crumbs and a polyurethane binder as mentioned hereinabove.

It has been found the use of such a urethane-modified isocyanate, based on a polyol from a nitrogen containing initiator(s), as the polyurethane binder system provides a more desirable reaction profile with enhanced cure and better workability thus facilitating preparation of a composite such as, for example, a sports surface. The enhancements in the cure profile offer operational and economic features as there is a significant reduction in waiting time before being able to proceed with the next steps in a manufacturing activity.

Use of the polyurethane binder comprising such urethane-modified isocyanate derived from a polyol based on the nitrogen containing initiator(s) permits reduction or even elimination of catalysts typically present to accelerate the curing of the polyurethane binder. This has the advantage of offering systems that have reduced sensitivity to water or humidity content of the particulate matter thus avoiding susceptibility to foam formation. With such reduced water sensitivity; less time is required in drying and preparing the particulate matter for manufacture of the composite. The ability to reduce or eliminate presence of curing catalysts means that such polyurethnae binders systems are now accessible to certain end applications previously excluded due to sensitivity associated with such catalyst substances.

### DETAILED DESCRIPTION

The composite article of this invention comprises particulate matter substantially coated with and bound together by a non-cellular polyurethane matrix, or binder, derived from the urethane-modified polyisocyanate disclosed herein. Typically the composite article will comprise the particulate matter in from about 50 to about 99, preferably in from about 60 to about 97, and more preferably in from about 75 to about 95 weight percent by based on total weight of the composite. Commensurately the non-foamed polyurethane matrix will constitute from about 1 to about 50, preferably from about 3 to about 40, and more preferably from about 5 to about 25 weight percent based 25 on total weight of the composite.

Such composite article may be a compact article but in some instances, such as for example when being a laminate component of a mat, may be semi-compact article containing voids. When the composite article is a semi-compact article typically it will comprise from about 50 to about 95 percent by weight of particulate matter and from about 5 to about 95 percent by weight of the non-cellular polyurethane binder and wherein the void volume of the composite is from about 15 to 85 percent by volume.

The particulate matter can be an inorganic or organic substance, or mixture thereof. Exemplary of inorganic substances are sand, quartz, marble or other ground stone, ground glass, or a cementious material. Composites based on inorganic matter such as sand can have utility in the foundry industry. Exemplary of organic substances are elastomeric crumb of rubber or reground foam material, or a particulate ligno-cellulosic substance such as, for example, cork, wood, grass or straw. The preferred particulate matter for the composite of this invention are organic substances including elastomeric rubbers, for example such as derived from styrene and butadiene, reground foam material or cork, and which optionally can be recovered/recycled materials. Such particulate matter is eminently suitable for the manufacture of composites having utility as surfaces, sound absorbing materials and upper or under layers in recreational surfaces or pavement or roofing or flooring such as a mat, pad or tile for carpeting. When preparing composite articles from the preferred types of particulate organic matter advantageously the average particle size in its longest dimension is less than about 20 mm, preferably less than about 15 mm and more preferably less than about 10 mm. For convenience of handling and processing, advantageously the average particles size is at least 1 mm, and preferably at least 3 mm in its longest dimension.

The non cellular polyurethane binder can be a two component polyurethane binder obtained by reaction of an isocyanate with an isocyanate-reactive material, other than water. Alternatively it can be a one-component binder obtained by curing of an isocyanate in the absence of other hydroxyl-containing substances, besides water. In both instances the isocyanate is a urethane-modified isocyanate obtained by reaction of a molar excess of a polyisocyanate with a polyol composition comprising a polyether polyol based on an initiator having a tertiary nitrogen atom. The urethane-modified isocyanate typically will have an average isocyanate content of from about 1 to about 23, preferably from about 5 to about 18 and more preferably from about 7 to about 14 weight percent.

The polyol composition used in preparation of the urethane-modified isocyanate may comprise one or more additional polyol(s) which are not initiated with an initiator containing a nitrogen atom. Such polyols are well known in the art and are described in such publications as High Polymers, Vol. XVI; “Polyurethanes, Chemistry and Technology”, by Saunders and Frisch, Interscience Publishers, New York, Vol. I, pp. 32-42, 44-54 (1962) and Vol II. Pp. 5-6, 198-199 (1964); Organic Polymer Chemistry by K. J. Saunders, Chapman and Hall, London, pp. 323-325 (1973); and Developments in Polyurethanes, Vol.

I, J. M. Burst, ed., Applied Science Publishers, pp. 1-76 (1978). Representative of suitable polyols include polyester, polylactone, polyether, polyolefin, polycarbonate polyols, and various other polyols. Preferably the additional polyol is a polyether or polyester polyol. If desired, the polyol formulation may also contain copolymer polyols such as those of styrene/acrylonitrile (SAN), polyisocyanate polyaddition products (PIPA) or polyurea polyols (PHD). The additional polyol(s) generally have a nominal hydroxyl functionality of 1.6 to 8 and a molecular weight of 1000 to 12,000.

The amount of polyol (b1) from the nitrogen-containing initiator present in the composition when preparing the urethane-modified isocyanate can be varied depending on degree of intrinsic reactivity required within the polyurethane binder systems for a given end application. Generally suitable compositions are when polyol (b1) is present in an amount of from about 5 to about 60, preferably from about 5 to about 50 and more preferably from about 5 to about 40 weight percent of the total weight of the polyol composition. The remainder of the polyol is from non-nitrogen containing initiators and the total weight percent of polyol is 100.

Polyol (b1) used to prepare the urethane-modified isocyanate is a substance typically having an average molecular weight of from about 1000 to about 12000 Daltons, preferably from about 1500 to about 8000, and more preferably from about 2000 to about 6000 and is obtained by alkoxylation of an initiator comprising at least one molecule of the formula
HₘA-(CH₂)ₙ—N(R)—(CH₂)ₚ-AHₘ Formula (I)
wherein n and p are independently integers from 2 to 6; A at each occurrence is independently oxygen, nitrogen, sulphur or hydrogen, with the proviso that only one of A can be hydrogen at one time;
R is a C₁ to C₃ alkyl group; m is equal to 0 when A is hydrogen, m is 1 when A is oxygen and m is 2 when A is nitrogen,
or of the formula
   H₂N—(CH₂)ₜ—N—(R)—H Formula (II)
where t is an integer from 2 to 12 and
R is a C₁ to C₃ alkyl group.

In a preferred embodiment of Formula I, R is methyl. In another preferred embodiment R is methyl and n and p are integers of the same value. In a more preferred embodiment n and p are an integer of 2 to 4. Preferably when A is not hydrogen, A at each occurrence will be either oxygen or nitrogen. In a more preferred embodiment one A will be oxygen and the other A will be nitrogen, and the final polyol will be a triol. In a yet more preferred embodiment, A is nitrogen in all occurrences and the final polyol will be a tetrol.

The alkyl amines of Formula I are commercially available or can be made by techniques known in the art, such as U.S. Pat. 4,605,772, the disclosure of which is incorporated herein by reference. For example, methylamine is reacted with the appropriate alkylene oxide for producing compounds where A is oxygen. Preferably the alkylene oxide is ethylene oxide (EO), propylene oxide (PO), or butylene oxides (BO), which gives a preferred range of 2 to 4 for n when each A is oxygen. Example of such initiator compounds are N-methyldiethanolamine, N-methyldipropanolamine, N-methyldibutanol-amine, N-methylethanol-propananol-amine.

For producing compounds where each A is nitrogen, methyl amine can be reacted with any known reactive group that reacts with an amine and contains additional nitrogen. For example, 2 moles of X(CH₂)ₙNR′R″ can be reacted with one mole of methylamine where X represents chlorine, bromine or iodine; R′ and R″ can be H or an alkyl group; and n is as defined above. Examples of such initiator compounds include 3,3′-diamino-N-methyldipropylamine, 2,2′-diamino-N-methyldiethylamine, 2,3-diamino-N-methyl-ethyl-propylamine.

For producing compounds where one A is nitrogen and one A is oxygen, one can use a process such as the one described in JP 09,012,516, the disclosure of which is incorporated herein by reference.

In one embodiment of Formula II, R is methyl. Preferable t in Formula II is an integer of 2 to 10, more preferably 2 to 6 and most preferred from 2 to 4. In a preferred embodiment, R is methyl and m is an integer of 2 to 4. Compounds of Formula II can be made by standard procedures known in the art. Examples of commercially available compounds of Formula II include N-methyl-1,2-ethanediamine and N-methyl-1,3-propanediamine.

The production of polyols by alkoxylation of an initiator can be done by procedures well known in the art. In general, a polyol is made by the addition of an alkylene oxide (EO, PO, or BO), or a combination of alkylene oxides to the initiator by anionic or cationic reaction or use of double metal cyanide (DMC) catalyst. For some applications only one alkylene oxide monomer is used, for other applications a blend of monomers is used and in some cases a sequential addition of monomers is preferred, such as PO followed by an EO feed or EO followed by PO.

In the present invention the polyisocyanate reacted in excess with the above described polyol composition comprises an aliphatic polyisocyanate or an aromatic polyisocyanate, or mixtures thereof. Suitable aliphatic polyisocyanates include hexamethylene diisocyanate and isophorone diisocyanate. Preferred are aromatic polyisocyanates including toluene diisocyanate, methylene diphenylisocyanate (MDI), including isomers thereof, and polymethylene polyphenylisocyanate (crude MDI). In a preferred embodiment the aromatic polyisocyanate is an isocyanate mixture that contains the 2-ring methylene diphenylisocyanate (MDI) isomers in at least about 40, preferably at least 50 and more preferably at least 60 weight percent of total isocyanate present. Preferably the MDI comprises the 2,4′- and 4,4′-methylene diphenylisocyanate isomers in a molar ratio of from about 10:90 to about 90:10, preferably from about 20:80 to about 80:20, more preferably in from about 20:80 to about 70:30. The balance of the isocyanate mixture when not methylene diphenylisocyanate can comprise toluene diisocyanate, hexamethylene diisocyanate, isophorone diisocyanate, polymethylene polyphenylisocyanate, carbodiimide or allophonate or uretonimine adducts of methylene diphenylisocyanate and mixtures thereof. Preferred isocyanates to make up the balance of the composition are polymethylene polyphenylisocyanate, carbodiimide or allophonate or uretonimine adducts of methylene diphenylisocyanate.

The urethane-modified isocyanate is prepared in a conventional way by combining the isocyanate and the polyol at 20-100° C. and if desired, in the presence of urethane-forming catalyst, such as a tertiary amine or tin compound. The relative amounts of the isocyanate and the polyol are chosen in such a way as to arrive at the desired free NCO content of the final product. The preparation of the prepolymer is a routine operation for those skilled in the art; see for example patent publication WO2004074343, incorporated herein by reference.

The present invention relates to a composite of particulate matter bound by a non-foamed polyurethane derived from the described urethane-modified isocyanate; and to laminate articles where one or more lamella can be composed of such a composite article. Methods of manufacturing such composite articles and laminates are extensively documented in the literature, incorporated herein by reference. Examples of such publications include U.S. Pat. Nos. 4,112,176; 4,025,579; 4,107,100; 4,614,686; 4,857,368; 5,514,722; 5,472,743; 6,565,918; 6,649,696; U.S. Patent Application 2002/022086; EP Publication 1,312,469; GB Patents 1,373,923; 1.359,761; 1,384,619; 1,509,108; and 2,035,336.

In brief, a process for manufacturing a composite being a particulate matter substantially coated and bound together by a non-foamed polyurethane binder comprises a first step of intimately contacting said particulate matter with a urethane-modified isocyanate composition and a subsequent step of permitting the resulting mixture to cure and give the composite article.

Ground rubber elastomeric composites useful in surfacings, sound absorbing materials, underlayers for recreational surfaces or other pavement or flooring can readily be prepared by coating the particulate matter, typically a ground vulcanized rubber with the polyurethane binder and bringing this mixture to a surface where it spread out and allowed to cure.

The urethane modified isocyanates of the present invention may also be used to prepare composites from inorganic particulate matter. For example, manufacture of artificial stone where quartz sand is bound using a polyurethane binder is disclosed in GB Patent 1,294,017.

Methods of manufacturing a mat with a textile surface, that can be composed of polypropylene fabric or tufted nylon or knitted polyester fabric or woven polyester; and an elastomer backing layer that includes elastomer crumbs, notably vulcanized rubber, and a polyurethane binder are disclosed in the following publications, incorporated herein by reference EP-A-1,518,668; EP-A-1511894; EP-A-1,511,893; and EP-1,549,797. In summary, such method involves mixing elastomer crumbs and a binder, depositing the crumb/binder mixture in a layer, placing a textile surface element on the layer to form a mat assembly, and pressing the mat assembly while setting the binder, so that the elastomer crumbs are consolidated to form an elastomer backing that includes voids between the elastomer crumbs, and the textile surface element is bonded to the elastomer backing.

The following examples are given to illustrate the invention and should not be interpreted as limiting in anyway. Unless stated otherwise, all parts and percentages are given by weight. VORANOL, ISONATE, and VORANATE are trademarks of The Dow Chemical Company
Polyol 1: a proprietary polyol from The Dow Chemical Company having a hydroxyl equivalent weight of about 1700 and being obtained by reacting 3,3′-diamino-N-methyldipropylamine with an EO/PO mix feed in the weight ratio of about 12:88.
Polyol A: a glycerine EO/PO polyol having a hydroxyl equivalent weight of about 1700 available from The Dow Chemical Company as VORANOL 1421.
Polyol B: a 4000 molecular weight diol based on propylene oxide with ethylene oxide capping available from The Dow Chemical Company as VORANOL EP1900.
Polyisocyanate A: A carbodiimide modified MDI available from The Dow Chemical Company as ISONATE 143L.
Polyisocyanate B: A 50:50 weight blend of 2,4′- and 4,4′-MDI available from The Dow Chemical Company as ISONATE OP 50.
Polyisocyanate C: A crude methylene diphenylisocyanate available from The Dow Chemical Company as VORANATE 229.

### EXAMPLE 1

A polyurethane binder according to the present invention (Binder 1 or 2) is prepared and compared in performance to Binders A and B considered representative of the general state of the art. The urethane-modified isocyanate compositions are prepared by reacting polyisocyanate with polyol as indicated below in Table I. The obtained binders are then mixed with a styrene-butadiene particulate rubber in the presence of a small amount of residual water and optionally in the presence of an amine catalyst JEFFCAT DMDEE available from Huntsman Chemicals and the resulting mixture is trowelled into a mold held a temperature of about 90° C. to give a tile having a thickness of 40 mm. The open time and drying time of the composition is reported in Table 1. The “open time” represents the period of time during which a mixture may be manipulated; longer openings times are generally advantageous in the field. The “drying time” represents the period of time in which the mixture must rest and cure before the next manufacturing operation can proceed; shorter “drying times” are generally desired in the field.

Binders 1 and 2 provide an attractive open time and provide a drying time superior to Binders A and B; and noticeably in the absence of a curing catalyst.

TABLE 1

| | 1 | 2 | A | B |
|---|---|---|---|---|
| Binder | | | | |
| (parts by weight) | | | | |
| Polyisocyanate A | 11.7 | 11.7 | 38.5 | |
| Polyisocyanate B | 24 | 24 | / | 29.7 |
| Polyisocyanate C | / | | / | 7.4 |
| Benzoylchloride | 0.1 | 0.1 | 0.1 | 0.1 |
| Polyol 1 | 28.8 | 19.6 | / | / |
| Polyol A | / | / | 12.0 | |
| Polyol B | 35.6 | 44.9 | 49.5 | 62.2 |
| Properties: | | | | |
| NCO % | 9.3 | 9.4 | 9.8 | 10.6 |
| Viscosity (mPas) at 20° C. | 5900 | 5350 | 5980 | 3200 |
| Styrene-butadiene rubber, | 100 | 100 | 100 | 100 |
| particle size ˜3 mm//water | | | | |
| content ˜0.5% | | | | |
| Amount of Binder | 9 | 9 | 9 | 9 |
| Jeffcat DMDEE | / | / | 0.75 | / |
| Open time (min) | 3.5-4.0 | 3.5-4.0 | 1.5-2.0 | 4.0-4.5 |
| Drying time (min) | 10 | 14 | 11 | 17 |

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

That what is claimed is:

1) A composite article composed of particulate matter substantially coated with a non-foamed polyurethane binder based on a urethane-modified isocyanate characterized in that, based on total weight of the composite article:
a) the particulate matter is present in from about 50 to 99 weight percent; and
b) the non-foamed polyurethane binder is present in from about 1 to about 50 weight percent and wherein urethane-modified isocyanate is the reaction product of:
i) a stoichiometric excess of an aliphatic or aromatic polyisocyanate, or mixtures thereof; with
ii) a polyol composition that comprises a polyether polyol (b1) having a molecular weight of from about 1000 to about 12000 and being obtained by alkoxylation of at least one initiator molecule of the formula
HₘA-(CH₂)ₙ—N(R)—(CH₂)ₚ-AHₘ Formula (I)
wherein n and p are independently integers from 2 to 6,
A at each occurrence is independently oxygen, nitrogen, sulphur or hydrogen, with the proviso that only one of A can be hydrogen at one time,
R is a C₁ to C₃ alkyl group,
m is equal to 0 when A is hydrogen, is 1 when A is oxygen and is 2 when A is nitrogen, or of the formula
H₂N—(CH₂)ₜ—N—(R)—H Formula (II)
where t is an integer from 2 to 12 and
R is a C₁ to C₃ alkyl group,

2) The composite article of claim 1 wherein the particulate substance is an organic material.

3) The composite article of claim 2 wherein the particulate organic substance comprises an elastomeric rubber or reground foam material, or a particulate ligno-cellulosic substance.

4) The composite article of claim 3 wherein the ligno-cellulosic substance comprises cork, wood, grass or straw.

5) The composite article of claim 1 wherein the particulate substance is an inorganic material.

6) The composite article of claim 5 wherein the inorganic particulate substance comprises sand, quartz, marble or other ground stone, ground glass, or a cementious material.

7) A process for manufacturing a composite article being of particulate matter substantially coated and bound together by a non-foamed polyurethane binder in which said process comprises a first step of intimately contacting said particulate matter with a urethane-modified isocyanate composition and a subsequent step of permitting the resulting mixture to cure and give the composite article characterized in that the urethane-modified isocyanate is the reaction product of:
a) a stoichiometric excess of an aliphatic or aromatic polyisocyanate, or mixtures thereof, with
b) a polyol composition that comprises a polyether polyol (b1) having a molecular weight of from about 1000 to about 12000 and being obtained by alkoxylation of at least one initiator molecule of the formula
HₘA-(CH₂)ₙ—N(R)—(CH₂)ₚ-AHₘ Formula (I)
wherein n and p are independently integers from 2 to 6,
A at each occurrence is independently oxygen, nitrogen, sulphur or hydrogen, with the proviso that only one of A can be hydrogen at one time,
R is a C₁ to C₃ alkyl group,
m is equal to 0 when A is hydrogen, is 1 when A is oxygen and is 2 when A is nitrogen, or
H₂N—(CH₂)ₜ—N—(R)—H Formula (II)
where t is an integer from 2 to 12 and R is a C₁ to C₃ alkyl group.

8. A laminate article having a first layer being in contact with a second layer and wherein at least one of the first or second layers is a composite as claimed in claim 1.

9. A mat with a tufted pile textile surface comprising tufts of yarn tufted into a tufting substrate and an elastomer backing, of elastomer crumb and binder, being a composite article as claimed in claim 1.

10. The mat of claim 9 obtained by the method including mixing elastomer crumbs and a binder, depositing the crumb/binder mixture in a layer, placing a textile surface element on the layer to form a mat assembly, and pressing the mat assembly while setting the binder, so that the elastomer crumbs are consolidated to form an elastomer backing that includes voids between the elastomer crumbs, and the textile surface element is bonded to the elastomer backing.
